(19) United States
(12) Patent Application Publication
(10) Pub. No.: US 2005/0027561 A1
(43) Pub. Date: Feb. 3, 2005

(54) Method and system for automated configuration of space, equipment and costs of health-care facility

(76) Inventors: Thomas Habenreich, Guntramsdorf (AT); Gerhard Hilscher, Wien (AT); Stefan Reimoser, Munich (DE)

Correspondence Address: SCHIFF HARDIN, LLP;PATENT DEPARTMENT, 6600 SEARS TOWER, CHICAGO, IL, 60606-6473, US

(21) Appl. No.: 10/630,466

(22) Filed: Jul. 30, 2003

(51) Int. Cl. G06F 17/60

(52) U.S. Cl. 705/2

(57) ABSTRACT

A method and computer-implemented system provides for planning of health-care facilities, including planning of space requirements, costs, equipment requirements for the health-care facility. User requirements are accepted as input information as to the departments and number of beds for the proposed health-care facility. Generic room data is applied to the inputted data and outputs are generated reporting total area of the facility, estimated costs and equipment requirements and costs. Output data can include breakdown area and costs per department and even per room.

### BACKGROUND OF THE INVENTION

1. Field of the Invention

The present invention relates generally to a method and system for generating planning information on a health-care facility, and in particular to a method and to a system implemented by a computer for generating space planning, cost planning and equipment planning information for a medical care facility,.

2. Description of the Related Art

There has been a lack of efficiency in the planning processes for health-care facility design and realization, and in particular a lack of standardized, knowledge-based tools for fast and transparent configuration of space requirements, equipment lists and cost estimates. In addition, building designs frequently dictate the processes happening inside and not vice versa as would be beneficial in order to best support the user's processes.

Usually, the process of integration and optimization of health-care facility design and construction is managed by an tremendous amount of coordination work, iterative procedures and manual integration of the findings. This methodology is accompanied by long durations for each project phase and high expenses for integration management. Interfaces between the various participants in the process (the user, consultants, and authorities) result in a loss of information and a lot of waste.

The necessary integration of: process (re-)engineering and process definition; medical equipment and information technology; and the physical environment (architecture) is often completely missed. Frequently, health-care facility planning is a set of partial solutions resulting in non-optimized project construction and eventually in sub-optimal business processes for the user.

The current methodology wastes resources, leaves unaccountable gaps in coverage, results in a loss of information and fails to build on the strength of the health professionals involved to ensure that the process is timely, appropriate and efficient.

In a recent publication “Accelerating Change”, The Strategic Forum for Construction, a UK-wide initiative for improving performance in the construction industry, chaired by Sir John Egan, specifies the following characteristics for high-performance enterprises in this sector:
A process that helps clients describe their needs . . .
Integrated teams [ . . . ] using an integrated IT approach
. . . a culture of continuous improvement.
   (see Accelerating Change, Strategic Forum for Construction, p. 10; http://www.rethinkingconstruction.org)

Available industry offerings typically address improvement needs at the level of single faculties involved but not on the level of the entire health-care facility programming and delivery. Supply chains are fragmented. Due to the complexity and timeframe of health-care projects, the feed-back from finished health-care facilities construction into current designs is unsatisfactory.

There is a need for the ability to configure a workflow-optimized health-care facility using a pre-defined process framework with clinician and space planner developed and reviewed content as well as associated methodologies for fast-track project design and cost documents.

There is a need for on-line cause and effect relationships (with reference to quality, area and costs) to be used in preliminary design phases of health-care facilities, which could significantly increase the efficiency of the health-care facility programming and design phase.

### SUMMARY OF THE INVENTION

The present invention provides a method and computer-implemented system to support the process definition, space configuration, cost estimation and equipment integration in health-care facilities. In particular, by using a health-care process framework with space and equipment allocations, the present method and system defines the ideally suited physical environments according to a user's requirements (which are used as input parameters). The result of the method and system includes space and costs estimates for the planned health-care facility as well as equipment lists, room data sheets, key performance indicators and documentation on the requirements. In one embodiment, the invention provides on-line programming of a customized and process optimized health-care facility.

### BRIEF DESCRIPTION OF THE DRAWINGS

FIG. 1 is a block diagram showing an overview of the method for the present invention;

FIG. 2 is a screen shot from a computer-implemented system embodying the present invention, showing a screen for user input into the system;

FIG. 3 is a screen shot of the detailed area portion for the computer-implemented system which performs the present method;

FIG. 4 is a screen shot of a cost estimation portion for the computer-implemented system of the present method;

FIG. 5 is a screen shot of the product cost display for the computer-implemented system; and

FIG. 6 is a screen shot of an example room data sheet produced by the computer-implemented system according to the present invention.

### DETAILED DESCRIPTION OF THE PREFERRED EMBODIMENTS

The invention provides an online documentation of user's requirements in the health-care facility planning process. The output is backed up by an optimized set of user's processes. The system allows a heretofore unseen flexibility in the programming phase, since changes do not require new, lengthy and costly iteration in the preliminary design phase, but only a “click”. User's processes and requirements are matched to a corresponding room program, the medical IT (Information Technology) and the equipment in a fast and efficient way.

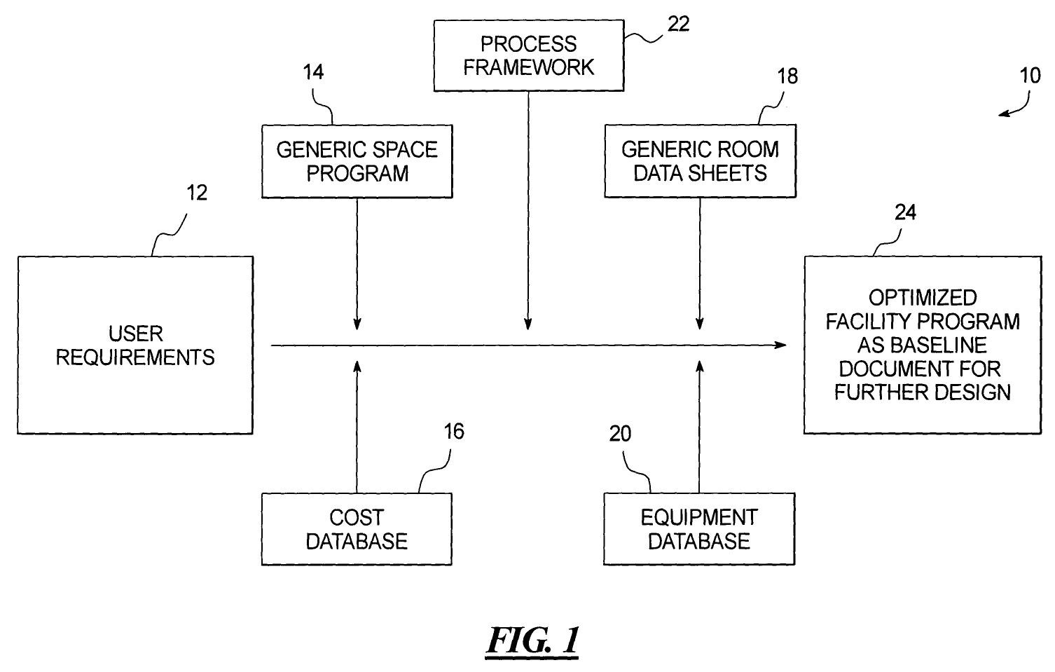

FIG. 1 shows an embodiment 10 of a method and system, which is preferably implemented by a computer, for generating a information relating to the health-care facility plan. In the method, user requirements 12 are received by the system. Within the system, a generic space allotment program 14 provides general information on space requirements for the requested features. A cost database 16 provides information on the estimated costs for each of the requested features. Generic room data sheets 18 are input to provide information on rooms, and an equipment database 20 is provided which has information on the special requirements of the equipment requested. This is supported by a process framework 22 that generates an output 24, here termed a document, having an optimized facilities plan. The process framework 22 is a tool which provides information on the best practices of clinical and operational processes in health-care enterprises. The findings from the process framework 22 are used to develop ideal room layouts and to constantly improve and optimize the required room quality, size and configurations. Information about the size is stored in the generic space program 14. The process framework 22 may directly interact with the generic space program, such as by having its output connected to the input of the generic space program 14. The optimized facilities plan 24 provides a baseline for further design changes as desired by the user, for example. In other words, the user may enter different user requirements to determine what changes are made in the output as a result

The present method is carried out on a computer system including data stored as database and spreadsheet data and applied as defined by the generic definitions and the user requirements. An example of a computer-implemented system for carrying out the present method is provided in the following figures.

The generic space allotment information is combined with the actual requirements of the user to create a customized space allotment program from the generic program. The algorithm behind this transformation is based on a set number of rooms for a specific number of beds and ambulatory care services per year. In one embodiment, a linear function is used, although a non-linear function is contemplated as well.

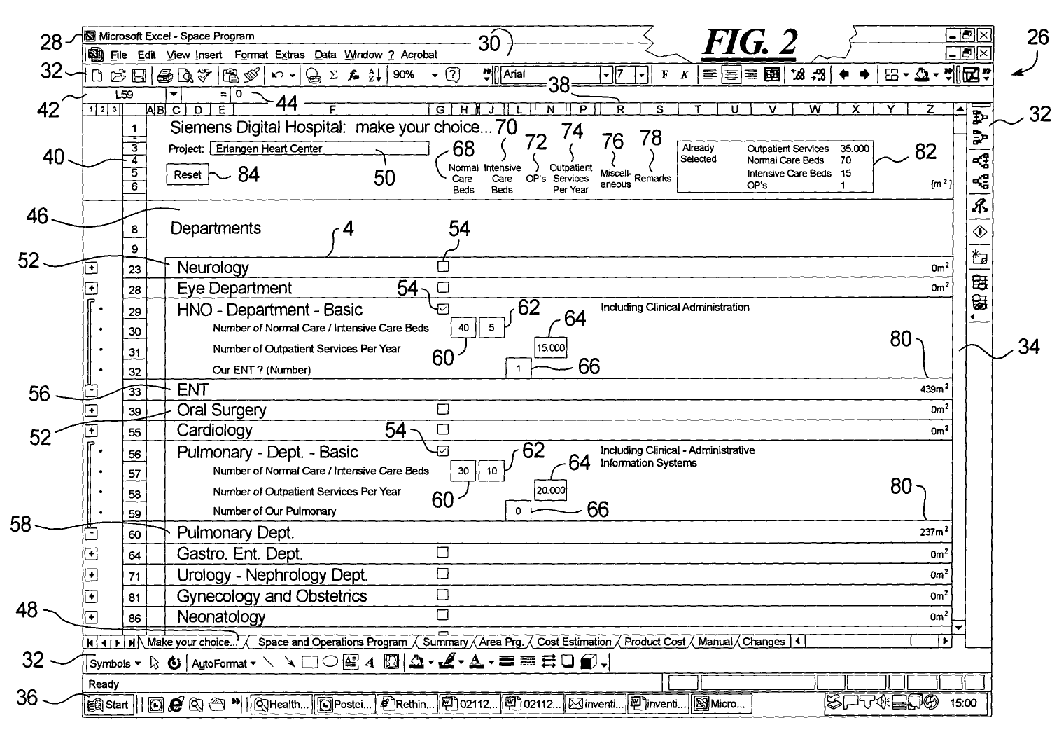

In FIG. 2, a screen shot 26 of a display screen for receiving user requirements information is shown. The screen is implemented in a spreadsheet program, such as Microsoft Excel running in a Microsoft Windows operating environment, such as Windows 98 or Windows XP, although other spreadsheets programs and other operating software are of course possible. The screen shot displays the title bar 28, menu bar 30, button bars 32, scroll bars 34, and the “start” button and task bar 36, as are familiar to all Windows users. The menu bar 32 lists the menus available, include file, edit, view, insert, format, extras, data, window, help and Acrobat. Within the Microsoft Excel program window is shown the column 38 and row 40 headings, name box 42 and formula bar 44, as are known. The worksheet area 46 of the Excel program shows the worksheets which embody the present invention. The various parts of the present program are accessed by selecting tabs 48, also termed sheet tabs, shown along the bottom of the screen, the screen shown in FIG. 2 being shown as the result of the selection of the first tab 48, entitled “Make your choice.”. Other tabs 48 shown access the Space and Operations Program, Summary, Area Program, Cost Estimation, Product Cost, Manual, and Changes. Nine such tabs are provided in the preferred embodiment, with only the first eight being visible in this screen shot.

Within the screen or worksheet area 46 following the screen title “Siemens Digital Hospital: make your choice.” is provided a text entry box for entering the name of the project being designed; here “Erlangen Heart Center” (Erlangen being a town in Germany) has been entered to as the name of the project for this example. A menu of possible specialized service areas or departments 52 are shown following the project name 50. In the present embodiment these departments 52 include, for example, neurology, ophthalmology, ear, nose and throat, dental and oral surgery, cardiology, pulmonary, gastro-enterology department, urology and nephrology department, gynecology and obstetrics, and neonatology. Each department name 52 is followed by a selection box 54. The list of possible specialized service areas continues with additional departments below the area show on the screen shot, these being accessed by movement of the vertical scroll bar 34, as is well known. Accordingly, the possible departments 52 which the user may select are greater than those identified here.

The user of the software selects the specialized service areas desired for the new or remodeled health-care facility by entering a selection in the selection box 54 following the corresponding department name. For example, this is accomplished by movement of the pointer, such as the mouse pointer, over the selection box and “clicking” the mouse selection button. Of course, it is well understood that selection of this item as well as others features of the program may be accomplished by any pointing and selecting device, including a computer mouse, touch pad, pointing stick, joy stick, trackball, touch screen or by operation of keys, usually combinations of keys, on a keyboard.

After a department 52 is selected, further information on the selected departments is requested of the user, such as the number of patients to be treated at one time, the number of treatment rooms desired, etc. For example, the user has selected the ear, nose and throat department 56 and the pulmonary department 58, as indicted by the check marks in the corresponding selection boxes 54. The selection of these departments has opened up a space on the display screen for entry of the further information by the user for a basic ear, nose and throat department and a basic pulmonary department. For the ear, nose and throat department, text boxes 60 and 62 show the number of normal care and intensive care beds (shown here has 40 and 5), the number of outpatient services 64 per year (shown here has 15,000) and the number of ear, nose and throat nurses and surgical physicians 66 (shown here as 1) has been entered. The information entry boxes 60, 62, 64, and 66 are located under columns entitled, normal care beds 68, intensive care beds 70, operating physicians 72, ambulatory services 74, miscellaneous 76, and remarks 78. Under the remarks column 78 is a note to include clinical administrative system information.

Similarly, a basic pulmonary department 58 has been selected and inquiries are made as to the number of normal care 60 and emergency care 62 beds (shown here as 30 and 10, respectively), the number of outpatient services 64 per year (shown here has 20,000) and the number of pulmonary health professionals 66 (shown here as 0). Both of the selected departments 56 and 58 indicate that they are to include clinical administrative system information. Entry of numbers into these question boxes 60, 62, 64, and 66 for the departments causes the program to calculate therefrom the area 80 required for these facilities, which is shown to the right in the corresponding department area. For example, the program has determined that the ear, nose and throat department will occupy 439 square meters and the pulmonary department will occupy 237 square meters.

A box 82 at the top of the screen provides information on what has been already selected, including number of outpatient services, number of normal and intensive care beds and number of health care professionals. A reset button 84 is also provided to return the selections to default values.

Following the completion of the department selections under the “make your choice . . . ” tab 48, the user of the program moves on to other tabs. Of course, the interactive nature of the present program permits the user to move back to a given tab to change selections therein so as to get a different result.

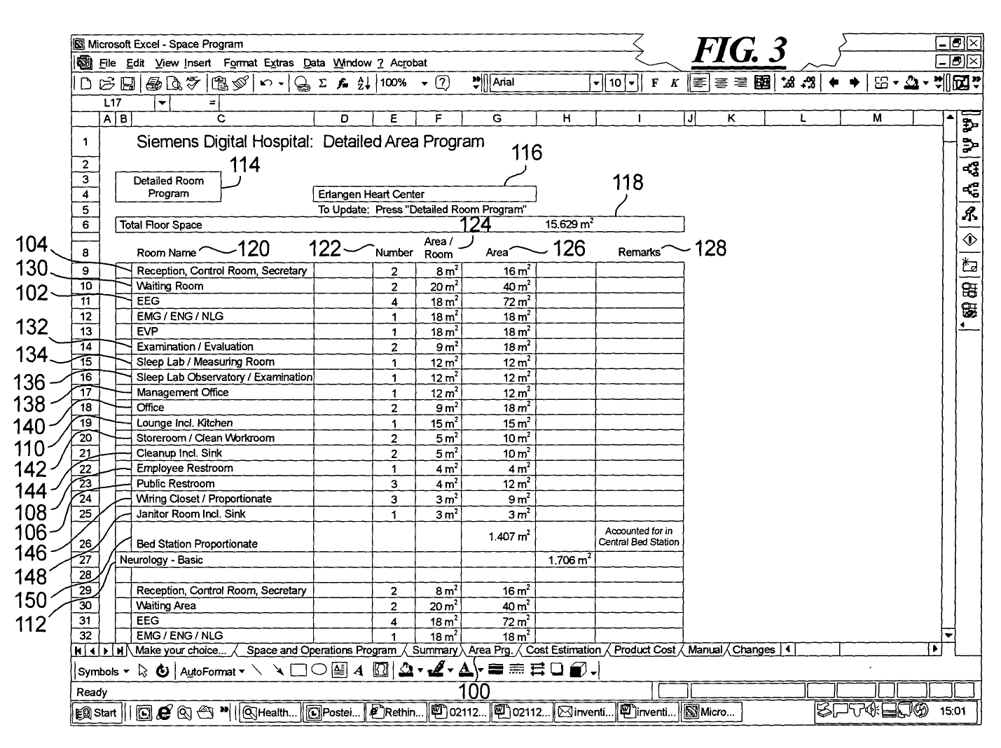

Referring to FIG. 3, the user of the program has selected the area program tab 100. The display provides a detailed listing of features of the rooms for the facilities, including specialized rooms such as EEG (electroencephalogram) rooms, and more mundane rooms as a reception area 104, public restrooms 106 and staff restrooms 108, kitchen area 110, etc. The rooms such as the reception area, restrooms and kitchen area may be considered common areas, whereas operating rooms, examination rooms, and patient treatment rooms are specific to each department. Each specialized area required for the facility based on the user input is treated in the detailed area program feature 112 of the method.

In particular, the worksheet area for the area program is shown the title, Siemens Digital Hospital: Detailed Area Program, and the subtitle box 114, Detailed Room Program. The project title 116 is shown, Erlangen Heart Center, under which it the instruction, to update: press “Detailed Room Program”. A calculation has been made for the health-care facility showing the total floor space 118 as 15,629 square meters.

In a row and column format is presented the following information, room name 120, number 122, area per room 124, area 126 and comment 128. Rooms shown in the illustrated example include: reception area with control room and secretary area 104, waiting area 130, EEG 102, examination and evaluation rooms 132, sleep lab and measuring area 134, sleep lab observation and examination area 136, management office 138, office 140, lounge and tea kitchen 110, entrance area 142, disposal area including sink 144, employee bathroom 108, patient bathroom 106, wiring closet —IT/electrical closet—proportionate 146, and janitor room including sink 148. The grayed out selection 150 indicates that the bed station proportionate is accounted for in the bed station.

Below the overall room information is a department by department breakdown with the same information available for each department. In the screen shot of the example, a basic neurology department 112 is shown.

Area information is matched to cost benchmark information, which is found in an editable overall benchmark of a cost estimation sheet. It is contemplated to assign individual cost benchmark figures to each room and department in the generic space program.

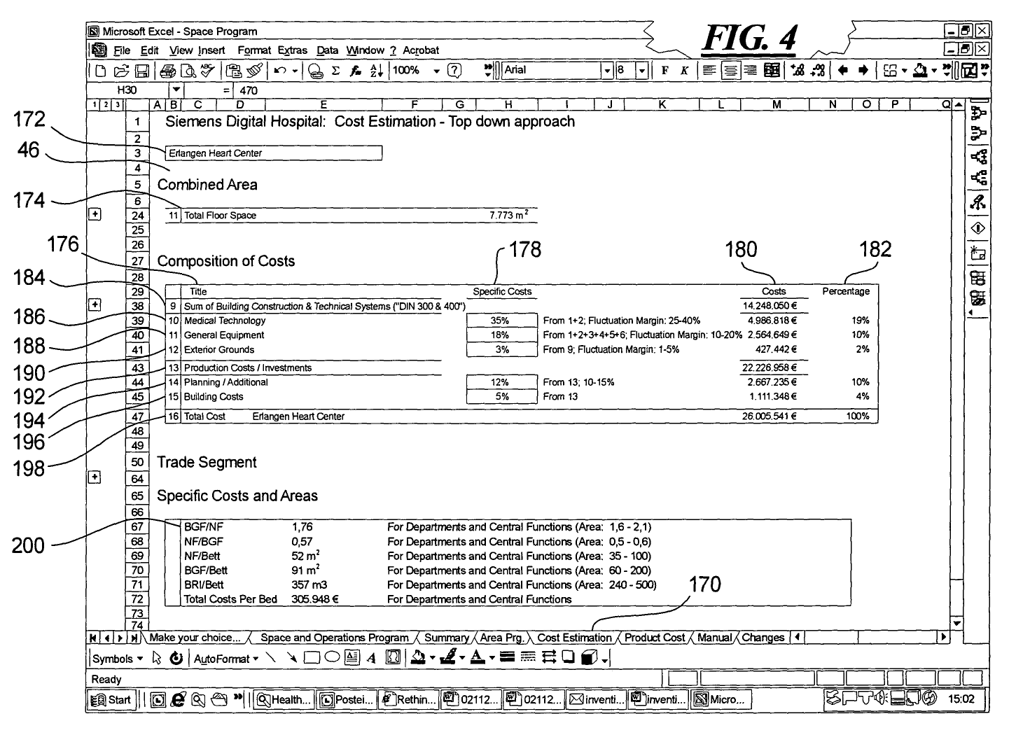

A cost estimate is provided in FIG. 4. The costs are presented in a top down approach, with the total costs presented, followed by a breakdown of those costs.

In particular, the worksheet area 46 has been selected by selecting the cost estimation tab 170, resulting in the screen entitled Siemens Digital Hospital: Cost Estimation—Top down approach being shown. Again, the project title 172 is shown, below which is information on the combined area. In box 174 is indicated the total floor space of 7,773 square meters for the project. Below the area information is the composition of combined costs area. Shown therein under the columns entitled title, specific costs 178, costs 180 and percentage 182 are items identified as sum of building construction and technical systems 184 (totaling 14,248,050 Euros) that includes medical technology 186, general equipment 188, exterior grounds 190, and production costs/investment 192 under which is planning/additional building costs 194 and reserve 196. Each of the sub-items has a percentage figure associated in column 178 with it as well as the source of the calculation and a fluctuation margin, and sub-item cost 180. Lastly, the total cost 198 of the medical facility is estimated.

Below the composition of combined costs area is a trade segment and thereunder a listing of specific values of area and costs. Under this area are provided information for departments and central functions with a breakdown 200 of costs per bed, floor space per bed, etc.

Each room is provided with the necessary equipment to fulfill its function. The product costs for the room provides the number of each item of equipment for the selections made in the “make your choice . . . ” worksheet and multiplies it by the unit prices of the equipment. The unit price information is an editable item in the product cost sheet of the program. The total equipment costs are thereby provided.

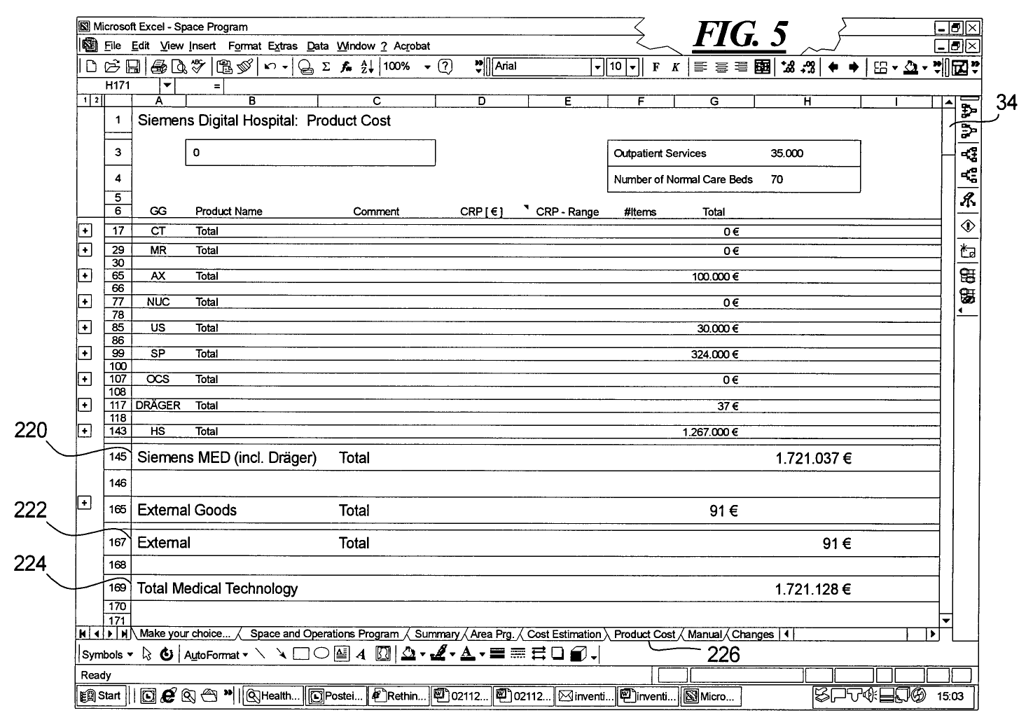

The facility costs are presented in FIG. 5. As before, the rest of the data is viewable by moving the scroll bar 34, but is not shown in this view. In the screen shot of the example, the total costs 220 are provided for the medical technology and costs of external goods 222 with a total cost 224 of the medical technology presented. The cost breakdowns provide cost information for the individual systems that make up the cost total. The facilities costs are accessed by selection of the tab 226.

Each room type in the generic space program is back up by a generic room data sheet which gives detailed information on the processes happening inside, the installed equipment, the electrical and HVAC requirements, the finishes, etc. It is also contemplated that the program picks the right sheets according to the user choices and collects them together with other summary sheets to provide a project specific workbook. The project workbook provides an immediate on-line comprehensive basis for further programming and design work.

The different requirements for each room are modeled, to some extent, on the department that room is associate with. So all examination rooms will not necessarily be equipped in the same way. For example, an examination room for one department may have some different equipment than an examination room for another department depending on the medical procedures or patient needs of that department. Wards within the health-care facility are centralized and are given similar sizes and qualities regardless of the department to which they are assigned. As an alternative, the present invention integrates department-specific information into the generic room type information so that rooms are further differentiated from department to department, for example as to size, finish, etc.

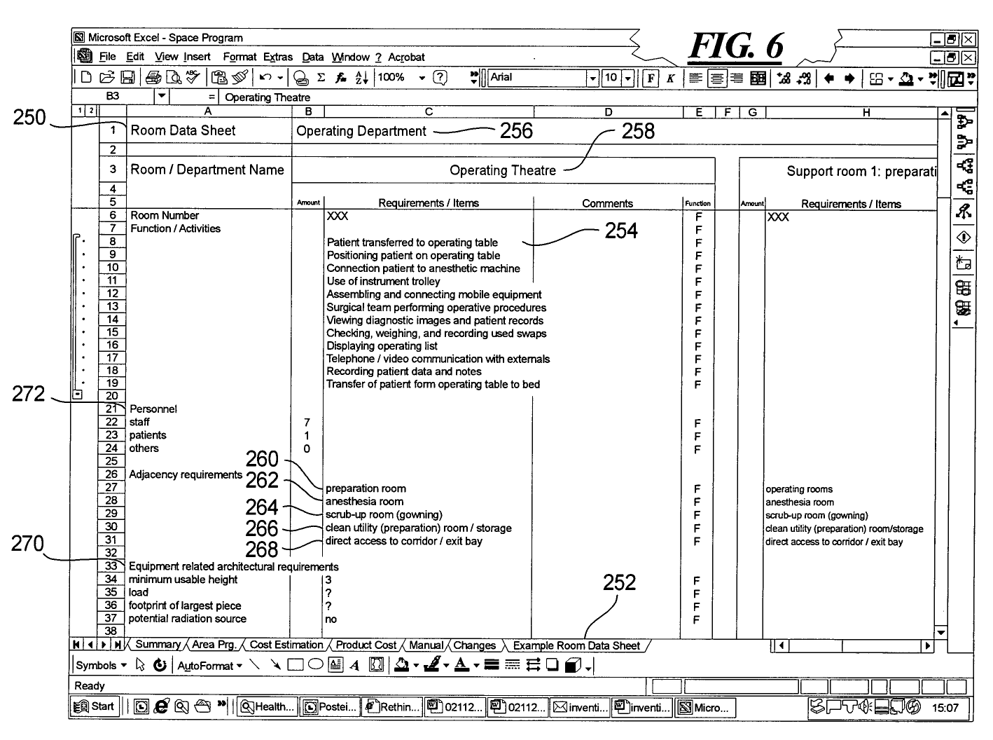

FIG. 6 provides an example of a room data sheet 250 that is viewed after selection of the tab 252 entitled “Example Room Data Sheet”. The room data includes a description of the services 254 to be performed in each room, so that the user has a full understanding of what is required for the rooms being provided according to the plan. For example, the room data sheet for the operating department (surgery department) 256 provides information on the operating theater 258 with its associated supporting rooms such as a preparation room 260, an anesthesia room 262, scrub up and gowning room 264, cleaning (utility) room and storage 266 and direct access to the corridor or exit bay 268. In this instance, the operating theater is a primary room for the operating, or surgical, department and the secondary rooms, such as a scrub and gowning room, anesthesia room, etc. are associated with it. Architectural requirements for equipment 270 for the room are provided such as information on the largest piece of equipment, whether is has a radiation source, the load requirements, etc. The personnel numbers 272 are also identified, indicating that the operating theater is sized for one patient and seven medical staff persons.

The output of the present program is information about the area or size of the health-care facility, a listing of the rooms including, for each department, the type of room, the individual size, the number of rooms, and the total area for the department. The output also includes an estimate for the building costs and possibly the cost of building each department. A list of equipment is provided for the entire facility as well as a listing of the equipment to be provided for each room type. The cost of the equipment for the facility and for each room type is also provided.

The output information from the present program is presented as text and is also presented as charts and tables.

Therefore, once a user enters the initial information on the facilities desired, the present program produces an output that includes
Requirements documentation
Space programs
Room data sheets
Equipment program and lists
Cost estimation (capital and operation) of the entire facility
Key performance indicators

The present invention can be used for planning of new health-care facilities or for remodeling of existing health-care facilities. The health-care facilities can be hospitals, clinics, doctors offices, or other facilities providing health-care services.

The present method and system promotes the focus of planning of a new health-care facility to be on development of new build schemes. A further application of the present invention is to apply the processes to existing structures to determine whether benchmarks are met, as well as to plan for further improvements in the facility.

The cost data generated by the program according to the present invention is based on costs of equipment and construction within the country and region of the planned health-care facility. Accordingly, different cost data is provided in the program for different countries and/or regions.

Although other modifications and changes may be suggested by those skilled in the art, it is the intention of the inventors to embody within the patent warranted hereon all changes and modifications as reasonably and properly come within the scope of their contribution to the art.

1. A method for space planning in a health-care facility, comprising the steps of:
receiving user requirements for a proposed health-care facility;
applying generic space allocations for health-care facilities to the user requirements;
applying a cost database for health-care facilities planning to the user requirements;
applying generic room data sheets for health-care facilities to the user requirements;
applying an equipment database for health-care facilities to the user requirements; and
generating output data for planning an health-care facility according to the user requirements.

2. A method as claimed in claim 1, wherein said output data includes area to be occupied by the health-care facility, estimated costs of constructing the health care facility and identification of equipment to be provided for the health-care facility.

3. A method as claimed in claim 1, wherein said step of receiving the user requirements includes identification of departments to be provided in the health-care facility.

4. A method as claimed in claim 3, wherein said step of receiving the user requirements includes identification of expected outpatient services and desired number of patient beds per department.

5. A method as claimed in claim 1, further comprising the step of:
applying said space planning method to an existing health-care facility.

6. A method as claimed in claim 1, wherein said step of generating output data includes: identifying rooms to be provided for a health-care facility.

7. A method as claimed in claim 1, wherein said step of generating output data includes: identifying associated supporting rooms for primary rooms of the health-care facility and including said primary rooms and said associated supporting rooms in said output data.

8. A method as claimed in claim 1, wherein said step of generating output data includes: generating a total estimated cost for the health-care facility.

9. A method as claimed in claim 8, wherein said step of generating output data includes: generating costs per department for the health-care facility.

10. A method as claimed in claim 1, further comprising the steps of:
identifying rooms to be provided in the health-care facility by room type; and
applying generic room data to each of the room types in the health-care facility.

11. A method as claimed in claim 1, further comprising the step of:
identifying items of equipment to be provided for types of rooms of the health-care facility.

12. A method as claimed in claim 11, further comprising the step of:
identifying cost of equipment for types of rooms of the health-care facility.

13. A computer-implemented system for planning a health-care facility, comprising:
an input process for accepting user information on a requested health-care facility;
generic room data and cost data and area data for room types in a health-care facility;
a process framework for applying the generic room data and area data and cost data to the user information; and
a display process for displaying output data for the health-care facility including area information and cost information and equipment information.

14. A computer-implemented system as claimed in claim 13, wherein said generic room type data includes room information for types of rooms in health-care facilities and said process framework applies said generic room type data to the user information.

15. A computer-implemented system as claimed in claim 13, wherein said input process includes identification of available departments for selection by the user.

16. A computer-implemented system as claimed in claim 15, wherein said input process includes an input process for receiving information from a user on a number of bed for each selected department and a number of outpatient services for each selected department and a number of health-care professionals for each selected department of the health-care facility.

17. A computer-implemented system as claimed in claim 13, wherein said display process displays output data for common areas of the health-care facility and for department areas of the health-care facility.

18. A computer-implemented system as claimed in claim 13, wherein said cost data displayed by said display process includes an estimate for total cost of the health-care facility and costs for systems within the health-care facility.

19. A computer-implemented method for planning a health-care facility, comprising the steps of:
presenting a listing of departments of health-care facilities to a user for selection;
receiving selections of departments from the user for a health-care facility;
requesting information on each selected department from the user;
receiving said information from said user for selected departments;
applying a process framework to said selections and said information from said user, said process framework applying generic room type data and cost data and area date to said selections and said information from said user;
generating an output of cost information and area information for the health-care facility.

20. A computer-implemented method as claimed in claim 19, wherein said step of generating generates an output of equipment information for the health-care facility.

21. A computer-implemented method as claimed in claim 19, wherein said cost information includes total estimated cost information and estimated cost information per selected department, and said area information includes total area information and area information per department.

22. A computer-implemented method as claimed in claim 19, wherein said cost information and area information includes information for common areas and for selected department areas.

23. A computer-implemented method as claimed in claim 19, further comprising the step of:
applying the method steps to a proposed health-care facility.

24. A computer-implemented method as claimed in claim 19, further comprising the step of:
applying the method steps to an existing health-care facility.

25. A computer-implemented method as claimed in claim 19, wherein said step of applying the process framework draws data from user requirements and generic space allocations and a cost database and an equipment database and generic room data.

26. A computer-implemented method as claimed in claim 19, further comprising the steps of:
receiving different user information after said step of generating the output; and
providing updated output information based on the different user information.
